(19) United States
(12) Patent Application Publication
(10) Pub. No.: US 2017/0133113 A1
(43) Pub. Date: May 11, 2017

(54) NUCLEAR REACTOR STRUCTURE

(71) Applicant: DCNS, Paris (FR)

(72) Inventor: Jean-Jacques INGREMEAU, Issy-les-Moulineaux (FR)

(21) Appl. No.: 15/321,760

(22) PCT Filed: Jun. 23, 2015
(86) PCT No.: PCT/EP2015/064103

§ 371 Date: Dec. 23, 2016

(30) Foreign Application Priority Data
Jun. 23, 2014 (FR) 14 01404

(51) Int. Cl. G21D 1/00; G21D 1/04

(52) U.S. Cl. CPC G21D 1/006; G21D 1/04

(57) ABSTRACT

This nuclear reactor structure (1) including a reactor vessel (2), at least one cylindrical steam generator (4) including a tube heat exchanger (9), the ends of which are connected to inlet (12) and outlet (13) compartments forming a water tank (10), connected to the vessel (2) forming a conduit (6), including a first conduit for transporting a heated fluid from the vessel (2) toward the steam generator (4) via the inlet compartment (12) of the water tank-forming unit (10), and a second conduit for transporting a cooled fluid from the steam generator (4) toward the vessel (2) via the outlet compartment (13) of the water tank-forming unit (10), is such that the conduit-forming unit (6) include a single line, the internal volume of which is divided to form the first and second conduits.

The present invention relates to a nuclear reactor structure, including:

a reactor vessel;

at least one cylindrical steam generator comprising a tube heat exchanger, the ends of which are connected to inlet and outlet compartments of means forming a water tank, connected to the vessel by means forming a conduit, comprising a first conduit for transporting a heated fluid from the vessel toward the steam generator via the inlet compartment of the water tank-forming means, and a second conduit for transporting a cooled fluid from the steam generator toward the vessel via the outlet compartment of the water tank-forming means.

In general and as is well known in the state of the art, a nuclear reactor structure traditionally includes a reactor vessel and at least one steam generator, for example cylindrical, comprising a tube heat exchanger.

Regarding steam generators of the recirculation type, the ends of the heat exchanger tubes are traditionally connected to inlet and outlet compartments of water tank-forming means connected to the vessel by fluid circulation conduit-forming means.

These conduit-forming means then comprise a first conduit for transporting a heated fluid from the vessel toward the steam generator via the inlet compartment of the water tank-forming means, and a second conduit for transporting a cooled fluid from the steam generator toward the vessel via the outlet compartment of the water tank-forming means.

In the state of the art, these conduits are formed by separate lines and are separated from one another, then extending between the vessel of the reactor and the steam generator.

These lines may have relatively significant lengths and include elbows hindering the natural convection of the primary heat transfer fluid.

One can then see that this structure has a certain number of drawbacks, in particular in terms of installation difficulties for such lines, problems connecting them, bulk issues, fluid circulation problems, in particular natural convection problems with the fluid, and problems related to the risk of major flaws forming in these lines.

The aim of the invention is therefore to resolve these problems, in particular to minimize the bulk of the structure, facilitate the natural convection of the fluid, and allow the use of anti-travel devices between the reactor vessel and the steam generator, to be able to rule out the aforementioned major flaws.

To that end, the invention relates to a nuclear reactor structure of the aforementioned type, wherein the conduit-forming means comprise a single line, the internal volume of which is divided to form first and second conduits.

According to other advantageous aspects of the invention, the nuclear reactor structure comprises one or more of the following features, considered alone or according to all technically possible combinations:

the water tank-forming means are arranged in the extension of the conduit-forming means;

the water tank-forming means are formed by a part separate from the steam generator;

the water tank-forming means are formed by a part separate and separated from the steam generator;

the water tank is cylindrical;

the water tank is coaxial to the steam generator;

the steam generator is horizontal;

the nuclear reactor structure comprises at least two steam generators arranged on either side of the vessel;

the steam generators extend radially from the vessel;

the vessel includes at least one primary pump;

at least some steam generators include at least one primary pump;

the first conduit is formed by an inner tube placed in an outer tube so as to define the second conduit of the line between them;

the inner tube and the outer tube are coaxial;

the single line includes an inner partition defining the first and second conduits on either side thereof,

the water tank-forming means are placed at the center of the steam generator and in that the heat exchanger includes tubes arranged symmetrically on either side of these water tank-forming means;

the water tank-forming means are placed at one end of the steam generator and in that the heat exchanger includes tubes extending therefrom.

The invention will be better understood using the following description, provided solely as an example and done in reference to the appended drawings, in which:

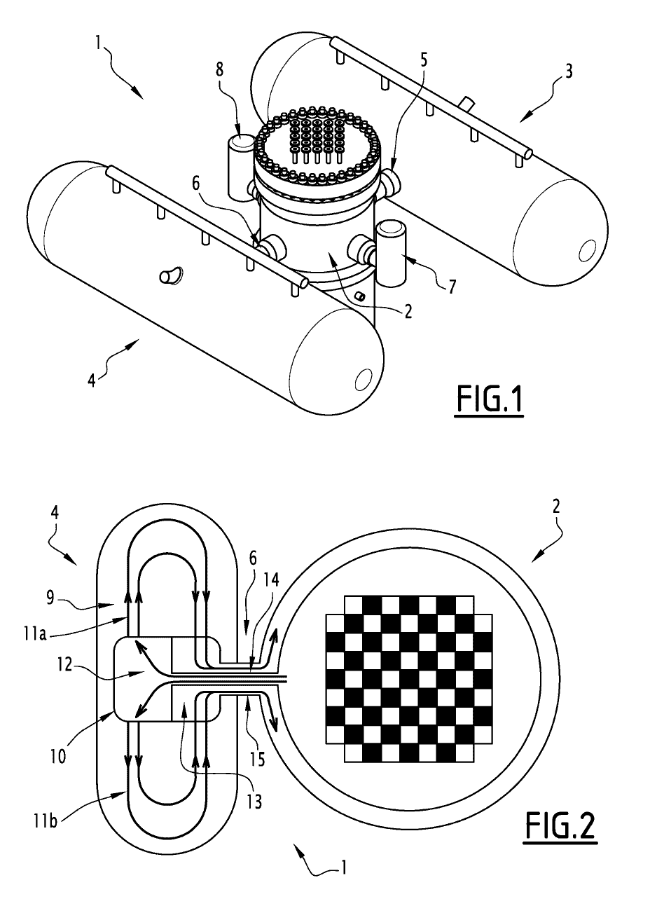

FIG. 1 shows a perspective view of one example embodiment of a nuclear reactor structure according to the invention;

FIG. 2 shows a diagrammatic cross-sectional view illustrating part of the example embodiment of the structure shown in FIG. 2;

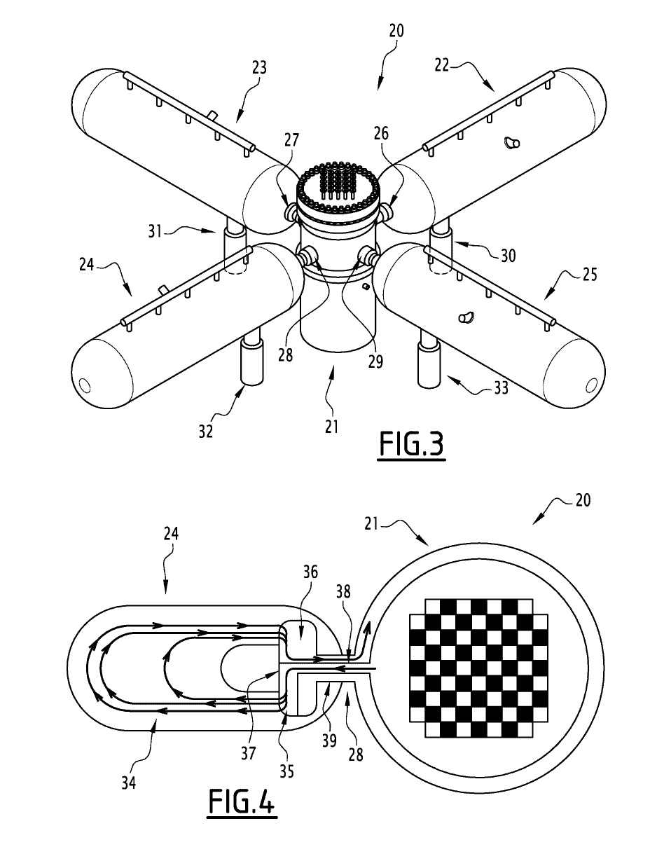

FIG. 3 shows a perspective view of an alternative embodiment of a nuclear reactor structure according to the invention; and

FIG. 4 shows a diagrammatic cross-sectional view illustrating part of the structure shown in FIG. 3.

In these figures, and in particular in FIG. 1, a nuclear reactor structure is illustrated and designated by general reference 1.

This structure traditionally includes a reactor vessel designated by general reference 2, and at least one steam generator, of the recirculation type, for example cylindrical.

In the example embodiment shown in this FIG. 1, two steam generators are illustrated and are designated by references 3 and 4, respectively.

As illustrated, the two steam generators 3, 4 are for example arranged symmetrically on either side of the reactor vessel 2 and extend horizontally.

Of course, and as will be described in more detail below, other embodiments may be considered.

The internal structure of the reactor vessel 2 will not be described in more detail below.

It will simply be noted that the or each steam generator 3, 4 illustrated in the figures traditionally comprises a tube heat exchanger.

The ends of these tubes are connected, traditionally and as will be described in more detail below, to inlet and outlet compartments of means forming a water tank, these inlet and outlet compartments of these water tank-forming means being connected to the reactor vessel 2 by fluid circulation conduit-forming means.

Thus for example, in FIG. 1, means forming a conduit for connecting the steam generators 3 and 4 to the reactor vessel 2 are illustrated and designated by references 5 and 6, respectively, in this figure.

Indeed and also traditionally, the conduit-forming means 5, 6 comprise a first conduit for transporting a heated primary fluid from the vessel 2 toward the corresponding steam generator via the inlet compartment of the water tank-forming means, and a second conduit for transporting a cooled primary fluid from the steam generator toward the vessel 2 via the outlet compartment of the water Lank-forming means.

As also illustrated in this FIG. 1, one or several primary fluid circulation pumps can be provided.

In FIG. 1, these primary pumps are associated with the reactor vessel 2.

Thus for example, two primary pumps arranged on either side of the vessel 2 and designated by references 7 and 8 are illustrated.

These pumps are also for example arranged symmetrically on either side of the vessel 2.

Of course, other arrangements may be considered.

FIG. 2 shows a diagrammatic cross-sectional view illustrating this reactor structure.

This FIG. 2 shows the main elements described in light of FIG. 1, namely the nuclear reactor structure designated by general reference 1, the reactor vessel designated by general reference 2, one of the steam generators, for example the steam generator 4, and the means forming a conduit for connecting this steam generator 4 to the reactor vessel 2, these conduit-forming means being designated by general reference 6.

As previously described, the steam generator 4 for example includes a tube heat exchanger that is illustrated diagrammatically and designated by general reference 9 in this FIG. 2.

The ends of this tube heat exchanger 9 are connected to inlet and outlet compartments of water tank-forming means.

These water tank-forming means are designated by general reference 10 in this FIG. 2. As previously described, these water tank-forming means 10 are connected to the reactor vessel 2 by the conduit-forming means 6.

In the example embodiment illustrated in FIG. 2, these water tank-forming means 10 are placed at the center of the steam generator 4, and the tube heat exchanger 9 then includes tubes arranged symmetrically and horizontally on either side of these water tank-forming means 10, for example tubes designated by references 11a and 11b in this figure.

As will be described in more detail below, other embodiments may be considered.

As shown in this FIG. 2, the fluid inlet ends of the tubes 11a and 11b are connected to an inlet compartment 12 of the water tank-forming means 10, while the outlet ends of these tubes 11a and 11b are connected to an outlet compartment 13 of these water tank-forming means 10.

These water tank-forming means 10 and these inlet 12 and outlet 13 compartments thereof are then connected to the reactor vessel 2 by the conduit-forming means 6.

As previously indicated, in the state of the art, two separate and separated lines are used to connect these inlet and outlet compartments of the water tank-forming means to the vessel.

To resolve the aforementioned problems relative to the use of these separate and separated lines, in the reactor structure 1 according to the invention, the conduit-forming means 5, 6 comprise a single line, the internal volume of which is divided to form first and second conduits.

This is in particular visible in FIG. 2, where one can see that the conduit-forming means 6 include a single line,

The first conduit is then formed by an inner tube 14 placed in an outer tube 15. The volume between the inner tube 14 and the outer tube 15 forms the second conduit of the line.

Indeed and according to the example embodiment illustrated in this FIG. 2, the inner tube 14 and the outer tube 15 can be coaxial.

The inner tube 14 then makes it possible to connect the reactor vessel 2 to the inlet compartment 12 of the water tank-forming means 10, and allows the heated fluid to pass, while the conduit defined by the volume between this inner tube 14 and the outer tube 15 makes it possible to connect the outlet compartment 13 of the water tank-forming means 10 to the reactor vessel 2 and allows the cooled fluid to pass.

Of course, other embodiments of the conduit-forming means 5, 6 may also be considered.

In particular, means other than inner 14 and outer 15 coaxial tubes can be used to define the conduits.

Thus for example, the single line including an inner partition defining the first second conduits on either side thereof, can also be used.

As also illustrated in this FIG. 2, the water tank-forming means 10 are arranged in the extension of the conduit-forming means 6.

These water tank-forming means 10 are formed by a part separate and optionally separated from the steam generator 4.

These water tank-forming means 10 can for example be cylindrical and coaxial to the steam generator 4 to maximize the surface of the tubes.

Of course, other embodiments can be considered.

This is for example the case of the nuclear reactor structure illustrated in FIGS. 3 and 4.

Thus, for example in FIG. 3, we have illustrated a nuclear reactor structure designated by general reference 20 that still includes a reactor vessel designated by general reference 21.

In this illustrated alternative embodiment, steam generators, for example four, designated by general references 22, 23, 24 and 25, are for example arranged horizontally and regularly around this reactor vessel 21 and extend radially therefrom.

Similarly to what has been described in light of FIGS. 1 and 2, these steam generators 22, 23, 24, 25 are connected to the reactor vessel 21 by conduit-forming means comprising a single line.

These means are respectively designated by general references 26, 27, 28 and 29 for the steam generators 22, 23, 24 and 25.

As also illustrated in this FIG. 3, at least some, and for example all, of the illustrated steam generators 22, 23, 24, 25 can also be equipped with at least one primary pump, for example respectively designated by references 30, 31, 32 and 33 in this FIG. 3.

FIG. 4 shows part of this reactor structure 20.

This FIG. 4 shows the reactor structure 20, the reactor vessel 21, and one of the steam generators, for example the steam generator 24, connected to the reactor vessel 21 by the single line 28.

The steam generator 24 then also includes a tube heat exchanger, like that designated by general reference 34 in this FIG. 4.

The inlet and outlet ends of the tubes of the tube heat exchanger 34 are respectively connected to inlet 35 and outlet 36 compartments of water lank-forming means 37, placed, in the illustrated example, coaxially to the steam generator 24 at one end thereof.

Similarly to what was described with respect to FIG. 2, the conduit-forming means comprising the single line 28 then also include an inner tube 38 placed in an outer tube 39.

This structure then makes it possible to define, in the inner tube 38, a first conduit for transporting a heated fluid from the reactor vessel 21 toward the steam generator 24 via the inlet compartment 35 of the water tank-forming means 37, and between this inner tube 38 and the outer tube 39, a second conduit for transporting a cooled fluid from the steam generator 24 toward the vessel 21 via the outlet compartment 36 of the water tank-forming means 37.

Also in this example body, the water tank-forming means 37 are formed by a part separate and for example separated from the steam generator 24.

Owing to this arrangement, the construction of the steam generator is simplified.

Indeed, in some nuclear reactor structures of the state of the art, the wall of the steam generator forms the wall of the water tank-forming means, in which case it is then necessary to reinforce the wall of the steam generator locally, in that location, such that it withstands the pressure of the primary fluid, which is about 150 bars.

In the structure according to the invention, it is not necessary to reinforce the wall of the steam generator; one simply sizes the water tank-forming means such that they withstand the primary pressure, the wall of the generator being sized to withstand the pressure of the secondary fluid, which is about 60 bars.

Of course, other embodiments can be considered.

One can then see that such a structure has a certain number of advantages in terms of simplifying the connection of the steam generator(s), and the exchangers thereof, to the reactor vessel, which results in improving the operating safety of this assembly and reducing the production costs thereof.

1-15. (canceled)

16. A nuclear reactor structure (1; 20), including:
a reactor vessel (2; 21),
at least one cylindrical steam generator (3, 4; 22, 23, 24, 25) comprising a tube heat exchanger (9; 34), the ends of which are connected to inlet (12; 35) and outlet (13; 36) compartments of means forming a water tank (10; 37), connected to the vessel (2; 21) by means forming a conduit (5, 6; 26, 27, 28, 29), comprising a first conduit for transporting a heated fluid from the vessel (2; 21) toward the steam generator (3, 4; 22, 23, 24, 25) via the inlet compartment (12; 35) of the water tank-forming means (10; 37), and a second conduit for transporting a cooled fluid from the steam generator (3, 4; 22, 23, 24, 25) toward the vessel (2; 21) via the outlet compartment (13; 36) of the water tank-forming means (10; 37),
wherein the conduit-forming means (5, 6; 26, 27, 28, 29) comprise a single line, the internal volume of which is divided to form the first and second conduits, the water tank-forming means (10) being placed at the center of the steam generator (4), the heat exchanger (9) including tubes (9, 11) arranged symmetrically on either side of these water tank-forming means (10).

17. The nuclear reactor structure (1, 20) according to claim 16, wherein the water tank-forming means (10; 37) are arranged in the extension of the conduit-forming means (5, 6; 26, 27, 28, 29).

18. The nuclear reactor structure (1, 20) according to claim 16, wherein the water tank-forming means (10; 37) are formed by a part separate from the steam generator (3, 4; 22, 23, 24, 25).

19. The nuclear reactor structure (1; 20) according to claim 16, wherein the water tank-forming means (10; 37) are formed by a part separate and separated from the steam generator (3, 4; 22, 23, 24, 25).

20. The nuclear reactor structure (1; 20) according to claim 16, wherein the water tank (10; 37) is cylindrical.

21. The nuclear reactor structure (1; 20) according to claim 16, wherein the water tank (10; 37) is coaxial to the steam generator (3, 4; 22, 23, 24, 25).

22. The nuclear reactor structure (1; 20) according to claim 16, wherein the steam generator (3, 4; 22, 23, 24, 25) is horizontal.

23. The nuclear reactor structure (1) according to claim 22, further comprising at least two steam generators (3, 4) arranged on either side of the vessel (2).

24. The nuclear reactor structure (20) according to claim 23, wherein the steam generators (22, 23, 24, 25) extend radially from the vessel (21).

25. The nuclear reactor structure (1) according to claim 16, wherein the vessel (2) includes at least one primary pump (6, 7).

26. The nuclear reactor structure (20) according to claim 16, wherein at least some of the steam generators (22, 23, 24, 25) include at least one primary pump (30, 31, 32, 33).

27. The nuclear reactor structure (1; 20) according to claim 16, wherein the first conduit is formed by an inner tube (14; 38) placed in an outer tube (15; 39) so as to define the second conduit of the line between them.

28. The nuclear reactor structure (1; 20) according to claim 27, wherein the inner tube (14; 38) and the outer tube (15; 39) are coaxial.

29. The nuclear reactor structure according to claim 16, wherein the single line includes an inner partition defining the first and second conduits on either side thereof.

30. The nuclear reactor structure (20) according to any claim 16, wherein the water tank-forming means (37) are placed at one end of the steam generator (24), the heat exchanger (34) including tubes extending therefrom.

31. The nuclear reactor structure (20) according to any claim 17, wherein the water tank-forming means (37) are placed at one end of the steam generator (24), the heat exchanger (34) including tubes extending therefrom.

32. The nuclear reactor structure (20) according to any claim 18, wherein the water tank-forming means (37) are placed at one end of the steam generator (24), the heat exchanger (34) including tubes extending therefrom.

33. The nuclear reactor structure (20) according to any claim 19, wherein the water tank-forming means (37) are placed at one end of the steam generator (24), the heat exchanger (34) including tubes extending therefrom.

34. The nuclear reactor structure (20) according to any claim 20, wherein the water tank-forming means (37) are placed at one end of the steam generator (24), the heat exchanger (34) including tubes extending therefrom.

35. The nuclear reactor structure (20) according to any claim 21, wherein the water tank-forming means (37) are placed at one end of the steam generator (24), the heat exchanger (34) including tubes extending therefrom.
